(19) United States
(12) Patent Application Publication
(10) Pub. No.: US 2026/0301709 A1
(43) Pub. Date: Oct. 1, 2026

(54) METHOD FOR DISPLAYING A SCREEN IN AN APPARATUS INCLUDING A TOUCH SCREEN AND THE APPARATUS

(71) Applicant: EFFINET SYSTEMS, INC., Seoul (KR)

(72) Inventors: Jin Cheol HWANG, Daegu (KR); Jun Nyun KIM, Gyeongsangbuk-do (KR)

(73) Assignee: EFFINET SYSTEMS, INC., Seoul (KR)

(21) Appl. No.: 19/241,284

(22) Filed: Jun. 17, 2025

(30) Foreign Application Priority Data
Mar. 25, 2025 (KR) 10-2025-0037781

(51) Int. Cl. G09G 5/00; G06F 3/041

(52) U.S. Cl. CPC G09G 5/003; G06F 3/0416; G09G 2320/0686; G09G 2340/0407; G09G 2354/00

(57) ABSTRACT

The present invention relates to a screen display apparatus and a method thereof, in which a single touch screen driven by a single driving board can be divided into a plurality of regions, with each region capable of independently displaying different content. The screen display apparatus includes: a touch screen; a screen mode switch for selecting between full screen mode and split screen mode; and a driving board including a controller and a scaler. The controller varies the touch recognition area based on the operation signal from the screen mode switch and displays content accordingly on the touch screen.

### CROSS-REFERENCE TO RELATED APPLICATION

This application claims priority under 35 U.S.C. § 119(a) to Korean Patent Application No. 10-2025-0037781 filed with the Korean Intellectual Property Office on Mar. 25, 2025. The disclosures of the above patent application is incorporated herein in by reference in their entirety.

### BACKGROUND

### Technical Field

The present invention relates to a screen display method and a screen display apparatus, and more particularly, to a screen display apparatus and method for dividing a single touch screen operated by one driving board into multiple display areas, each independently rendering different content.

### Description of the Related Art

Generally, gaming machines such as slot machines or pachinko machines are used in casinos or entertainment centers.

These machines operate on the principle where reels with various symbols rotate and stop based on user interaction, rewarding the player if matching symbols align.

However, such traditional game machines can become monotonous due to the singular gameplay focus and may lead to user fatigue.

Thus, there is a need for display devices capable of displaying not only game content but also additional types of content to enrich user engagement.

### SUMMARY

An object of the present invention is to provide a screen display method and apparatus in which a single touch screen operated by one driving board can be divided into multiple sections, each independently displaying different content.

One embodiment is a screen display apparatus. The screen display apparatus includes: a touch screen; a screen mode switch configured to set either a full screen mode or a split screen mode; and a driving board including a scaler and a controller. The controller is configured to vary a touch recognition area based on an operation signal from the screen mode switch and to display content on the touch screen.

Another embodiment is a screen display method. The screen display method includes: receiving an operation signal from a screen mode switch for setting either a full screen mode or a split screen mode; setting a touch recognition area differently based on the operation signal: and displaying content on the touch screen.

According to embodiments of the present disclosure, it is possible to divide a single screen into multiple regions with independent functionality and allow varied content display using a single driving board. Thus it is possible to lead to reduced hardware costs.

### DESCRIPTION OF DRAWINGS

FIG. 1 is a drawing illustrating the screen display apparatus according to an embodiment of the present invention

FIG. 2 is flowchart illustrating the screen display method according to an embodiment.

FIG. 3 is a drawing illustrating view of content displayed in full screen mode.

FIG. 4 is a drawing for explaining display options in split screen mode.

FIG. 5 is a drawing for explaining display options in split screen mode.

### DETAILED DESCRIPTION

Hereinafter, exemplary embodiments of the present disclosure will be described in further detail with reference to the accompanying drawings.

It is to be understood that, unless obviously and clearly noted or specified otherwise within the specification, singular forms of the terms used herein may include plural forms of the corresponding terms. In the description of the invention, the terms “consist(s) of” or “include(s) (or comprise(s))” should not be interpreted or understood as including, without exception, all of the plurality of elements (or components) or the plurality of steps disclosed in the description of the invention. In other words, it should be understood that some (or part) of the elements (or components) or some (or part) of the steps may not be included, or that additional elements (or components) or steps may be further included in the present invention.

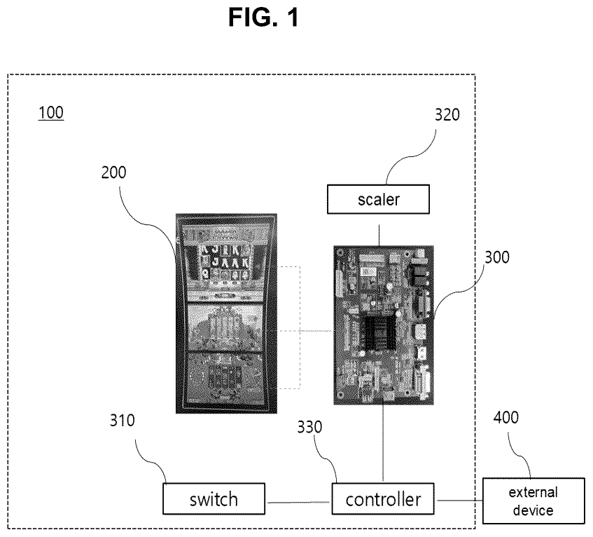

FIG. 1 is a drawing illustrating the screen display apparatus according to an embodiment of the present invention Referring to FIG. 1, a screen display apparatus 100 according to an embodiment of the present invention includes a touch screen 200 and a driving board 300.

The touch screen 200 functions both as an input device that receives touch input and as a display device that presents content. A designated region (not shown) on the touch screen 200 is configured as a touch recognition area to detect touch input.

A screen mode switch 310 generates a signal for selecting between full screen mode and split screen mode. The switch may be implemented in either hardware or software.

The driving board 300 may include a scaler 320 and a controller 330.

The scaler 320 is typically implemented as a chip and can convert the display between full screen and split screen modes based on the operation of the screen mode switch 310.

The controller 330 sets different touch recognition areas based on the signal from the screen mode switch 310 and displays content accordingly on the touch screen 200.

The scaler 320 may operate under the control of the controller 330.

The controller 330 may communicate with an external device 400, such as a computer or ultra-mobile PC (UMPC). Depending on the implementation, the controller 330 and external device 400 may be either separate or integrated as a single unit.

The controller 330 may include a processor and control circuitry (not shown). The processor controls overall operations of the controller 330 and performs logic processing. It may also communicate with the external device 400.

In one embodiment, the processor is implemented as an ASIC (Application Specific Integrated Circuit) including the aforementioned functions in hardware. In another embodiment, the processor may be a general-purpose processor or a DSP (Digital Signal Processor) that loads and executes firmware to control operations.

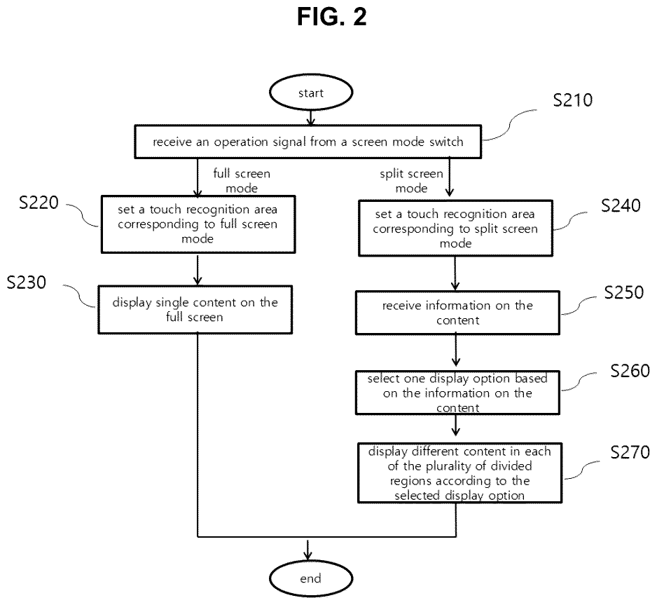

FIG. 2 is flowchart illustrating the screen display method according to an embodiment.

Referring to FIG. 2, the controller 330 receives an operation signal from the screen mode switch 310 (S210).

If the signal indicates full screen mode, the controller 330 configures a designated region of the touch screen 200 as the touch recognition area (S220). In this mode, a single content is displayed across the entire touch screen (S230).

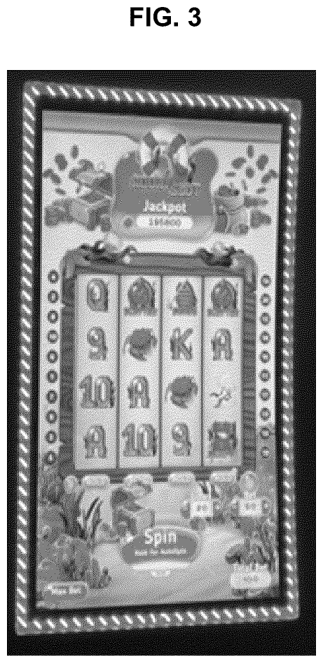

FIG. 3 is a drawing illustrating view of content displayed in full screen mode.

If the signal indicates split screen mode, the controller 330 configures the touch recognition areas according to the split mode (S240). For example, the screen may be divided into three regions, and corresponding touch recognition areas are defined for each region.

If a touch input is detected in the first touch recognition area corresponding to the first region, the controller 330 performs a first operation associated with the content displayed in that region. Similarly, if a second touch input is detected in the second touch recognition area, a second operation is performed based on the second region's content. These operations are independent of each other.

In another embodiment, one of the split regions may be set as a “main region,” in which touch recognition is enabled while the others do not accept touch input. This main region may be set automatically or manually.

When split screen mode is activated, the controller 330 receives information on the content from the external device 400 (S250). This information on the content may include optimal resolution data for rendering the content.

The controller 330 selects one from among a plurality of display options based on this information (S260).

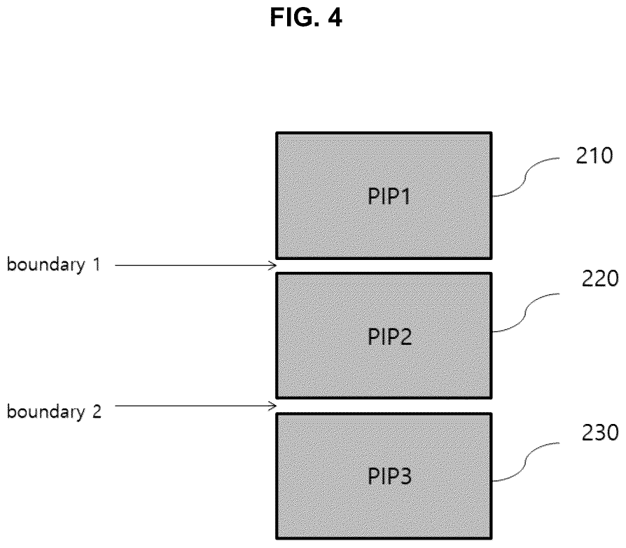

FIG. 4 is a drawing for explaining display options in split screen mode.

As illustrated in FIG. 4, the screen may be divided into three regions (210, 220, 230) with boundaries between them (boundary 1 between 210 and 220, boundary 2 between 220 and 230). The display options may define the resolution and boundary treatment.

For example:
Option P1: All three regions are set to 2160×1215 resolution with black boundary patterns.
Option P2: All three regions are set 2160×1280 without any boundary patterns.
Option P3: Mixed resolutions (e.g., 2160×1215 for region 1, 2160×1264 for regions 2 and 3), with selective boundary patterns (e.g., black pattern on boundary 1 only).

The boundary patterns may vary in design, such as solid black or a combination of black and silk colors. If no pattern is applied, content may extend into the boundary, effectively enlarging the display area.

In an alternative embodiment, users may manually select the display options regardless of content information.

The controller 330 displays multiple pieces of content independently in their respective split regions according to the selected display option (S270).

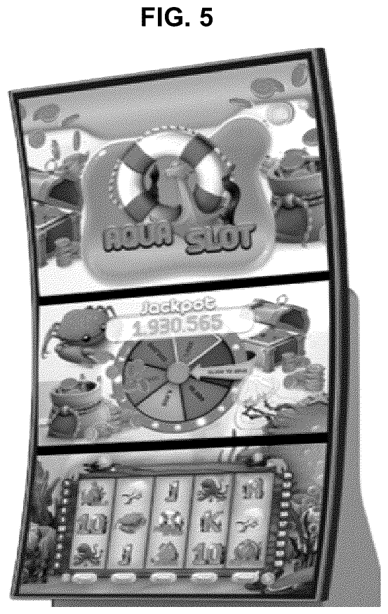

FIG. 5 is a drawing for explaining display options in split screen mode.

As shown in FIG. 5, the controller 330 displays 3 contents independently in their respective split regions according to the selected display option.

According to an embodiment of the present invention, it is possible to divide a single screen into multiple regions with independent functionality and allow varied content display using a single driving board. Thus it is possible to lead to reduced hardware costs.

1. A screen display apparatus comprising:
a touch screen;
a screen mode switch configured to set either a full screen mode or a split screen mode; and
a driving board including a scaler and a controller,
wherein the controller is configured to vary a touch recognition area based on an operation signal from the screen mode switch and to display content on the touch screen,
wherein, when the split screen mode is set by the screen mode switch, the controller divides the tough screen into a plurality of divided regions and displays different contents in the plurality of divided regions, respectively,
wherein the controller receives optimal resolution information for rendering the contents from an external device,
wherein the controller selects a resolution of each divided region and a boundary treatment of each boundary between the divided regions based on the received optimal resolution information, the boundary treatment specifying whether a boundary pattern exists and a type of the boundary pattern for the each boundary,
wherein the controller displays the different contents in the plurality of divided regions, respectively, according to the selected resolution and boundary treatment.

2. The screen display apparatus of claim 1, wherein the plurality of divided regions comprise a first divided region, a second divided region, and a third divided region.

3. The screen display apparatus of claim 1, wherein the controller adjusts the resolution of each divided region using the scaler.

4. The screen display apparatus of claim 1,
wherein the controller:
sets a plurality of touch recognition areas corresponding respectively to the plurality of divided regions,
performs a first operation related to content displayed in a first divided region upon receiving a first touch input in a first touch recognition area, and
performs a second operation related to content displayed in a second divided region upon receiving a second touch input in a second touch recognition area, wherein the first operation and the second operation are independent of each other.

5. The screen display apparatus of claim 1,
wherein the controller sets one of the plurality of divided regions as a main region and enables a touch recognition area only in the main region.

6-8. (canceled)
